(19) United States
(12) Patent Application Publication
(10) Pub. No.: US 2020/0234165 A1
(43) Pub. Date: Jul. 23, 2020

(54) PREDICTION METHOD FOR AERO-ENGINE STARTING EXHAUST TEMPERATURE

(71) Applicant: DALIAN UNIVERSITY OF TECHNOLOGY, Dalian, Liaoning (CN)

(72) Inventors: Rui WANG, Dalian, Liaoning (CN); Min LIU, Dalian, Liaoning (CN); Shuo ZHANG, Dalian, Liaoning (CN); Jibang LI, Dalian, Liaoning (CN)

(21) Appl. No.: 16/629,893

(22) PCT Filed: Jan. 26, 2018
(86) PCT No.: PCT/CN2018/074353

§ 371 Date: Jan. 9, 2020

(51) Int. Cl. G06N 7/00; F02C 7/00; G06N 20/20

(52) U.S. Cl. CPC G06N 7/005; F05D 2260/81; G06N 20/20; F02C 7/00

(57) ABSTRACT

A prediction method for an aero-engine starting exhaust temperature. A prediction model for the engine starting exhaust temperature is obtained by using a machine learning-based method and aero-engine ground test data. The model has high prediction accuracy and good generalization ability. The prediction result can be further used for engine control, etc., reducing the possibility of overheating of the engine. Compared with the traditional single parameter prediction, this contains more information because of using fusion prediction, so that prediction errors are reduced; and compared with the single prediction algorithm, this assembles weak learner by means of an AdaBoost. RT ensemble algorithm, so that the prediction errors are smaller.

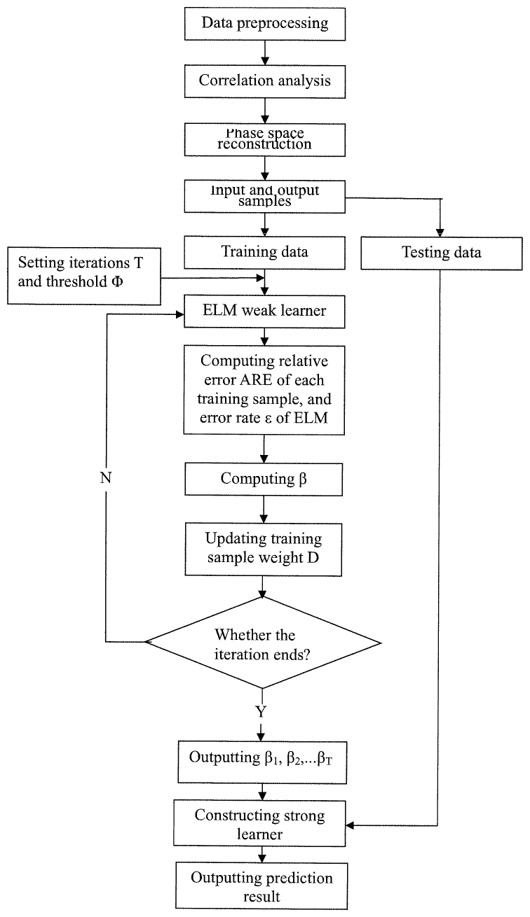

### TECHNICAL FIELD

The present invention belongs to the technical field of aero-engine prediction, and in particular to a prediction method for aero-engine starting exhaust temperature.

### BACKGROUND

When an aircraft is started, the aero-engine is in a state of high temperature, high load and high speed, and the possibility of overheating of the engine is high, and that will increase the flight risk. Therefore, there is a need to predict the exhaust temperature to control the aero-engine in time so as to prevent overheating. There are three main kinds of prediction methods for the aero-engine exhaust temperature, i.e. a model-based method, a regression-based method and a machine learning-based method. Wherein the model-based method is complex in computation, and may have problems such as iteration dose not converge during real time computing, etc.; in the regression-based method, sometimes there is no obvious linear or other function relationship between variables, so it is difficult to choose the model; however, the machine learning-based method has very a strong nonlinear mapping ability and short training time. In the literature Aeroengine Exhaust Gas Temperature Prediction Using Support Process Vector Machine, a support process vector machine model is proposed by Yu Guangbin, et al. and is applied to aero-engine exhaust temperature prediction to predict the gas path performance degradation law of the aero-engine, and it has a high prediction accuracy. In the literature Application of Neural Networks in Forecasting Engine Systems Reliability, a neural network is used by Xu K, et al. to predict the aero-engine exhaust temperature so as to predict engine system failure and reliability. The above methods are all based on the exhaust temperature of multiple flight cycles of the aero-engine as data to conduct prediction so as to show the performance state and degradation of the aero-engine, but they do not involve exhaust temperature prediction during entire starting. Therefore, it is impossible for them to control the engine before overheating.

### SUMMARY

To solve the technical problem about how to fill the gap in aero-engine starting exhaust temperature prediction, the present invention provides a prediction method for aero-engine starting exhaust temperature. A prediction model for the engine starting exhaust temperature is obtained by using the machine learning-based method and aero-engine ground test data. The model has high prediction accuracy and good generalization ability. The prediction result can be further used for engine control, etc.

In accordance with the present invention, a prediction method for aero-engine starting exhaust temperature is provided. The technical solution of the present invention is as follows:

first, preprocessing aero-engine ground test data collected by a sensor such as high pressure rotor speed, low pressure rotor speed, oil pressure and low pressure turbine rear temperature, which mainly includes outlier identification and processing, data smoothing and data normalization; then, based on the idea of information fusion, selecting parameters with high correlation with the exhaust temperature as input parameters by means of an appropriate correlation method to predict the exhaust temperature; in addition, conducting phase space reconstruction on the selected parameters to construct input and output samples; and finally, predicting the exhaust temperature by means of a machine learning algorithm, and obtaining a prediction model for the aero-engine starting exhaust temperature with high prediction accuracy, strong generalization ability and good robustness.

Preferably, in the present invention, outliers are identified by means of a density-based method and then are eliminated. Data smoothing is conducted by means of a special function smoothing method. Correlation analysis is conducted by means of a mutual information method. The parameters on which phase space reconstruction is conducted are based on the mutual information method and a Cao method respectively. The AdaBoost.RT ensemble algorithm is used as the machine learning algorithm, and a strong learner with a superior effect is obtained by integrating a weak learner, i.e. an extreme learning machine (ELM).

The present invention has the following advantageous effects: the prediction model of the present invention has high prediction accuracy, strong generalization ability and good robustness, and can predict the aero-engine starting exhaust temperature in real time; the prediction result can be further used for engine control, etc., reducing the possibility of overheating of the engine. Compared with the traditional single parameter prediction, the present invention contains more information because of using fusion prediction, so that prediction errors are reduced; and compared with the single prediction algorithm, the present invention integrates the weak learner by means of the AdaBoost.RT ensemble algorithm, so that the prediction errors are smaller.

### DESCRIPTION OF DRAWINGS

The sole FIGURE is a flow chart of the present invention.

### DETAILED DESCRIPTION

To make the purpose, the technical solution and the advantages of the present invention more clear, the present invention will be further described below in detail in combination with the drawing and technical solution.

I. Preprocessing of Aero-Engine Starting Ground Test Data

Supposing the aero-engine starting ground test data Data collected by a sensor is

Data=[Para₁,Para₂, . . . ,Paraₗ, . . . ,Para_{N}] (1)

Paraₗ={xₗᵢ}ᵢ₌₁ⁿ,l=1,2, . . . ,N (2)

where Para represents aero-engine performance parameter data such as high pressure rotor speed, low pressure rotor speed, oil pressure and low pressure turbine rear temperature, {xₗᵢ}ᵢ₌₁ⁿ, represents corresponding time series, N represents number of parameters, and n represents number of samples; preprocessing of aero-engine starting ground test data includes outlier point identification and processing, data smoothing and data normalization.

1. Density-Based Outlier Point Identification

In the time series {xₗᵢ}ᵢ₌₁ⁿ, the fewer the number of points near the point xₗᵢ is, which means the density of points around it is smaller, the more the point xₗᵢ is likely to be an outlier point. For an efficient point pair (xₗᵢ,xₗⱼ) formed by any two points in the time series {xₗᵢ}ᵢ₌₁ⁿ, the Euclidean distance thereof can be expressed as:

dist(xₗᵢ,xₗⱼ)=\sqrt{(xₗᵢ−xₗⱼ)²} (3)

for the point xₗᵢ of the efficient point pair (xₗᵢ,xⱼ₎, the k near neighbor point distance (k>0, k∈N) is defined as k−dist(xₗᵢ), and k−dist(xₗᵢ) satisfies that:
(1) in {xₗᵢ}ᵢ₌₁ⁿ, the number of data points satisfying dist(xₗᵢ,xₗⱼ)≤k−dist(xₗᵢ) is at least k; and
(2) in {xₗᵢ}ᵢ₌₁ⁿ, the number of data points satisfying dist(xₗᵢ,xₗⱼ)<k−dist(xₗᵢ) is at most k−1.

For the point xₗᵢ of the efficient point pair (xₗᵢ,xₗⱼ),

r−distₖ(xₗᵢ,xₗⱼ)=max(dist(xₗᵢ,xₗⱼ),k−dist(xₗᵢ)) (4)

is called the k near neighbor point limit distance of the efficient points xₗᵢ and xₗⱼ.

To measure the number of points around the xₗᵢ point, the concept of local limit density is defined, and

$$lrd ( {x}_{lj} ) = \frac{k}{{\sum }_{{x}_{li} ∈ K ( {x}_{lj} )} r - {dist}_{k} ( {x}_{li} , {x}_{lj} )} \qquad ( 5 )$$

is called the k local limit density of the point xₗⱼ, where K(xₗⱼ) represents the k near neighbor point set of the point xₗⱼ.

$$λ = \frac{1}{lrd ( {x}_{lj} )}$$

is defined as an outlier coefficient of the point xₗⱼ, if λ<ρ, the point xₗⱼ is a normal data point, if λ≥ρ, the point xₗⱼ is an outlier point of the time series {xₗᵢ}ᵢ₌₁ⁿ, where ρ represents the upper limit of outlier factors.

The identified outlier points are eliminated, and the positions of the eliminated outlier points are filled with the mean values of the adjacent data values at the left end and right end.

2. Quadric Exponential Smoothing Method-Based Data Smoothing

Processing data Data¹ on which outlier point identification and processing are conducted by using a quadric exponential smoothing method to remove noise or data contamination that may occur during signal collection, where

Data¹=[Para₁¹,Para₂¹, . . . ,Paraₗ¹, . . . ,Para_{N}¹] (6)

Paraₗ¹={xₗᵢ¹}ᵢ₌₁ⁿ,l=1,2 . . . ,N (7)

Para¹ represents aero-engine performance parameter data of Para on which outlier point identification and processing are conducted, and {xₗᵢ¹}ᵢ₌₁ⁿ represents time series of {xₗᵢ}ᵢ₌₁ⁿ on which outlier identification and processing are conducted.

The quadric exponential smoothing algorithm is as follows:

$$\{ \begin{matrix}{S}_{l i}^{( 1 )} = α {x}_{l}^{1} + ( 1 - α ) {S}_{li - 1}^{( 1 )} \\ {S}_{li}^{( 2 )} = α {S}_{li}^{( 1 )} + ( 1 - α ) {S}_{li - 1}^{( 2 )}\end{matrix} \qquad ( 8 )$$

where α represents a smoothing coefficient; Sₗᵢ⁽¹⁾,Sₗᵢ⁽²⁾ represent primary and secondary smoothing values respectively, and the initial smoothing value Sₗ₀ is defined as

$${S}_{l 0} = \frac{1}{n} {\sum }_{i = 1}^{n} {x}_{li}^{1} \qquad ( 9 )$$

3. Data Normalization

Normalizing the smoothed data Data² and converting it into data within the range of [0,1], where

Data²=[Para₁²,Para₂², . . . ,Paraₗ², . . . ,Para_{N}²] (10)

Paraₗ²={xₗᵢ²}ᵢ₌₁ⁿ,l=1,2 . . . ,N (11)

Para² represents aero-engine performance parameter data of Para¹ on which smoothing is conducted, and {xₗᵢ²}ᵢ₌₁ⁿ represents time series of {xₗᵢ¹}ᵢ₌₁ⁿ on which smoothing is conducted.

II. Correlation Analysis of Aero-Engine Starting Ground Test Data

Conducting correlation analysis on the preprocessed data Data³ by means of the mutual information method, where

Data³=[Para₁³,Para₂³, . . . ,Paraₗ³, . . . ,Para_{N}³] (12)

Paraₗ³={xₗᵢ³}ᵢ₌₁ⁿ,l=1,2 . . . ,N (13)

Para³ represents aero-engine performance parameter data of Para² on which normalization is conducted, and {xₗᵢ³}ᵢ₌₁ⁿ represents time series of {xₗᵢ²}ᵢ₌₁ⁿ on which normalization is conducted.

Supposing there are two sets of aero-engine performance parameter data Paraₚ³={xₚᵢ³}=ᵢ₌₁ⁿ and Para_{q}³={x_{qj}³}=ⱼ₌₁ⁿ, where p,q∈N and p≠q. The probability densities of xₚᵢ³ and x_{qj}³ are Pxₚ[xₚᵢ³] and Px_{q}[x_{qj}³] respectively, and the joint probability density is Px_{pq}[xₚᵢ³,x_{qj}³], then the mutual information function MI(xₚ,x_{q}) is

$$\begin{matrix}M I ( {x}_{p} , {x}_{q} ) = H ( {x}_{p} ) + H ( {x}_{q} ) - H ( {x}_{p} , {x}_{q} ) & ( 14 ) \\ H ( {x}_{p} ) = - {\sum }_{i = 1}^{n} {Px}_{p} [ {x}_{pi}^{3} ] log \{ {Px}_{p} [ {x}_{pi}^{3} ] \} & ( 15 ) \\ H ( {x}_{q} ) = - {\sum }_{j = 1}^{n} {Px}_{q} [ {x}_{qj}^{3} ] log \{ {Px}_{q} [ {x}_{qj}^{3} ] \} & ( 16 ) \\ H ( {x}_{p} , {x}_{q} ) = - {\sum }_{i = 1 , j = 1}^{n} {Px}_{pq} [ {x}_{pi}^{3} , {x}_{qj}^{3} ] log \{ {Px}_{pq} [ {x}_{pi}^{3} , {x}_{qj}^{3} ] \} & ( 17 )\end{matrix}$$

Computing the mutual information function values of each parameter and exhaust temperature; taking into account the difference in the correlation between each parameter and exhaust temperature and the time requirement for training the prediction model, taking three parameters and exhaust temperatures (EGT) with the maximum mutual information function value as input parameters of the prediction model.

III. Phase Space Reconstruction of Aero-Engine Starting Ground Test Data

Because the aero-engine starting ground test data is a set of time series data, in order to fully show the implied information therein, phase space reconstruction is conducted on one-dimensional time series data. Conducting phase space reconstruction on data Data⁴ on which correlation analysis is conducted, where

Data⁴=[Para₁³,Para₂³,Para₃³,Para₄³] (18)

Paraₗ³={xₗᵢ³}ᵢ₌₁ⁿ,l=1,2,3,4 (19)

specifically, Para₄³=EGT³. For the time series {xₗᵢ³}ᵢ₌₁ⁿ, the reconstructed phase space thereof is

Xₗ=[Xₗ₁,Xₗ₂, . . . ,X_{lI}, . . . ,X_{lM}]^{T} (20)

where

X_{lI}=[x_{lI},x_{l(I+τ)}, . . . ,x_{l(I+(m-1)τ)}],I=1,2, . . . ,M;M=n−(m−1)τ (21)

m represents embedding dimension, and τ represents the delay time, which are solved by the mutual information method and Cao method respectively. Input and output samples are constructed according to phase space reconstruction, as shown in Table 1, where h represents prediction step.

TABLE 1
Phase Space Reconstruction-Based Input and Output Data

| Number of samples | Input data X | Output data Y |
|---|---|---|
| 1 | [X₁₁, X₂₁, X₃₁, X₄₁] | EGT_{1+(m-1)τ+h}³ |
| . . . | . . . | . . . |
| I | [χ_{1I}, X_{2I}, X_{3I}, χ_{4I}] | EGT_{I+(m-1)τ+h}³ |
| . . . | . . . | . . . |
| M | [X_{1M}, X_{2M}, X_{3M}, X_{4M}] | EGT_{M+(m-1)τ+h}³ |

IV. Prediction Model for Aero-engine Starting Exhaust Temperature

The present invention predicts the aero-engine starting exhaust temperature by means of AdaBoost.RT_ELM algorithm, wherein the specific AdaBoost.RT_ELM algorithm is as follows:

(1) Input

input and output data {X_{I},Y_{I}}_{I=1}^{M} after phase space reconstruction;

selecting a weak learning algorithm {fₜ}ₜ₌₁^{T};

specifying iterations T (also indicating the number of weak learners finally generated);

specifying the threshold ϕ of the absolute relative error, and dividing the training samples into correctly predicted samples and incorrectly predicted samples according to ϕ during training.

(2) Initialization

letting initial iterations t=1;

letting the training sample weight distribution during the first training Dₜ(I)=1/M,I=1, . . . ,M;

letting initial error rate εₜ=0.

(3) Iteration process

for t=1, . . . , T:

Step 1: training the t^{th} weak learner on the training sample with the weight of Dₜ;

Step 2: recording the prediction result of the t^{th} learning machine fₜ for the I^{th} sample X_{I} as fₜ(X_{I}), and the actual true value as Y_{I}; computing the error rate of fₜ:

$${ɛ}_{t} = {\sum }_{I} {D}_{t} ( I ) , I \text{:} \vert \frac{{f}_{t} ( {X}_{I} ) - {Y}_{I}}{{Y}_{1}} \vert > φ \qquad ( 22 )$$

Step 3: setting βₜ=εₜ^{a}, where a may be 1, 2 or 3;

Step 4: updating the sample weight Dₜ:

$${D}_{t + 1} ( I ) = \frac{{D}_{t} ( I )}{{Z}_{t}} \times \{ \begin{matrix}{β}_{t} , \vert \frac{{f}_{t} ( {X}_{I} ) - {Y}_{I}}{{Y}_{I}} \vert \leq φ \\ \begin{matrix}1 , & \end{matrix}\end{matrix} \qquad ( 23 )$$

where Zₜ represents a normalization factor; adjusting the weight of each sample, i.e. increasing the weight of samples with large prediction errors and reducing the weight of samples with small prediction errors, so that the samples with large errors are more concerned in the next iteration.

end

(4) Output

strong learner:

$${f}_{fin} ( x ) = \frac{{\sum }_{t} \{ ( log ( 1 \text{/} {β}_{t} ) ) \times {f}_{t} ( X ) \}}{{\sum }_{t} ( log ( 1 \text{/} {β}_{t} ) )} \_ \qquad ( 24 )$$

The present invention uses an extreme learning machine (ELM) with high learning speed and good generalization ability as a weak learner, and through setting appropriate iterations and thresholds, obtains a strong learner with high prediction accuracy, i.e. the prediction model for aero-engine starting exhaust temperature.

1. A prediction method for aero-engine starting exhaust temperature, comprising: for the aero-engine starting ground test data collected by a sensor, conducting outlier point identification and processing on the data by means of a density-based method, smoothing or filtering noise or data contamination in the data by means of a quadric exponential smoothing method, and normalizing the data to convert same into data within the range of [0,1];
based on the idea of information fusion, conducting correlation analysis by means of a mutual information method, computing the mutual information function values of each parameter and exhaust temperature; taking into account the difference in the correlation between each parameter and exhaust temperature and the time requirement for training the prediction model, taking three parameters and exhaust temperatures with the maximum mutual information function value as input parameters of the prediction model; supposing the preprocessed data is Data, where
Data=[Para₁,Para₂, . . . ,Paraₗ, . . . ,Para_{N}] (1)
Paraₗ={xₗᵢ}ᵢ₌₁ⁿ,l=1,2, . . . ,N (2)
where Para represents aero-engine performance parameter data, {xₗᵢ}ᵢ₌₁ⁿ represents corresponding time series, N represents number of parameters, and n represents number of samples;
supposing there are two sets of aero-engine performance parameter data Paraₚ={xₚᵢ}ᵢ₌₁ⁿ and Para_{q}={x_{qj}}ⱼ₌₁ⁿ, where p,q∈N and p≠q the probability densities of xₚᵢ and x_{qj} are Pxₚ[xₚᵢ] and Px_{q}[x_{qj}] respectively, and the joint probability density is Px_{pq}[xₚᵢ,x_{qj}], then the mutual information function MI(xₚ,x_{q}) is
$$\begin{matrix}M I ( {x}_{p} , {x}_{q} ) = H ( {x}_{p} ) + H ( {x}_{q} ) - H ( {x}_{p} , {x}_{q} ) & ( 3 ) \\ H ( {x}_{p} ) = - {\sum }_{i = 1}^{n} {Px}_{p} [ {x}_{p i} ] log \{ {Px}_{p} [ {x}_{p i} ] \} & ( 4 ) \\ H ( {x}_{q} ) = - {\sum }_{j = 1}^{n} {Px}_{q} [ {x}_{qj} ] log \{ P {x}_{q} [ {x}_{qj} ] \} & ( 5 ) \\ H ( {x}_{p} , {x}_{q} ) = - {\sum }_{i = 1 , j = 1}^{n} {Px}_{pq} [ {x}_{pi} , {x}_{qj} ] log \{ {Px}_{pq} [ {x}_{pi} , {x}_{qj} ] \} & ( 6 )\end{matrix}$$
conducting phase space reconstruction on the selected parameters to construct input and output samples so as to fully show the implied information in the time series data; supposing the data on which correlation analysis is conducted is Data¹, where
Data¹=[Para₁,Para₂,Para₃,Para₄] (7)
Paraᵣ={xᵣᵢ}ᵢ₌₁ⁿ,r=1,2,3,4 (8)
specifically, Para₄=EGT; for the time series {xₗᵢ}ᵢ₌₁ⁿ, the reconstructed phase space thereof is
Xₗ=[Xₗ₁,Xₗ₂, . . . ,X_{lI}, . . . ,X_{lM}]^{T} (9)
where
X_{lI}=[x_{lI},x_{l(I+τ)}, . . . ,x_{l(I+(m-1)τ)}],I=1,2, . . . ,M;M=n−(m−1)τ (10)
where m represents embedding dimension, and τ represents delay time, which are solved by the mutual information method and a Cao method respectively; according to phase space reconstruction, input and output samples are constructed, as shown in Table 1, where h represents prediction step;
TABLE 1
Phase Space Reconstruction-Based Input and Output Data

| Number of samples | Input data X | Output data Y |
|---|---|---|
| 1 | [X₁₁, X₂₁, X₃₁, X₄₁] | EGT_{1+(m-1)τ+h} |
| . . . | . . . | . . . |
| I | [χ_{1I}, X_{2I}, X_{3I}, χ_{4I}] | EGT_{I+(m-1)τ+h} |
| . . . | . . . | . . . |
| M | [X_{1M}, X_{2M}, X_{3M}, X_{4M}] | EGT_{M+(m-1)τ+h} |

predicting the aero-engine starting exhaust temperature by means of an AdaBoost.RT_ELM algorithm, wherein the specific AdaBoost.RT_ELM algorithm is as follows:
(1) input
input and output data {X_{I},Y_{I}}_{I=1}^{M} after phase space reconstruction;
selecting a weak learning algorithm {fₜ}ₜ₌₁^{T};
specifying iterations T;
specifying the threshold ϕ of the absolute relative error, and dividing the training samples into correctly predicted samples and incorrectly predicted samples according to ϕ during training;
(2) initialization
letting initial iterations t=1;
letting the training sample weight distribution during the first training Dₜ(I)=1/M,I=1, . . . ,M;
letting initial error rate εₜ=0;
(3) iteration process
start
for t=1, . . . , T;
step 1: training the t^{th} weak learner on the training sample with the weight of Dₜ;
step 2: recording the prediction result of the t^{th} learning machine fₜ for the I^{th} sample X_{I} as fₜ(X_{I}), and the actual true value as Y_{I}; computing the error rate of fₜ:
$${ɛ}_{t} = {\sum }_{I} {D}_{t} ( I ) , I \text{:} \vert \frac{{f}_{t} ( {X}_{I} ) - {Y}_{I}}{{Y}_{I}} \vert > φ \qquad ( 11 )$$
step 3: setting βₜ=εₜ^{a}, where a may be 1, 2 or 3;
step 4: updating the sample weight Dₜ:
$${D}_{t + 1} ( I ) = \frac{{D}_{t} ( I )}{{Z}_{t}} \times \{ \begin{matrix}{β}_{r} , \vert \frac{{f}_{r} ( {X}_{I} ) - {Y}_{I}}{y} \vert \\ 1 , \text{Other}\end{matrix} \leq φ \qquad ( 12 )$$
where Zₜ represents a normalization factor; adjusting the weight of each sample, i.e. increasing the weight of samples with large prediction errors and reducing the weight of samples with small prediction errors, so that the samples with large errors are more concerned in the next iteration;
end
(4) output
strong learner:
$${f}_{fin} ( x ) = \frac{{\sum }_{t} \{ ( log ( 1 \text{/} {β}_{t} ) ) \times {f}_{t} ( X ) \}}{{\sum }_{t} ( log ( 1 \text{/} {β}_{t} ) )} \qquad ( 13 )$$
using an extreme learning machine with high learning speed and good generalization ability as a weak learner, and by setting appropriate iterations and thresholds, obtaining a strong learner with high prediction accuracy, i.e. the prediction model for the aero-engine starting exhaust temperature.
